(19) United States
(12) Patent Application Publication
(10) Pub. No.: US 2021/0104225 A1
(43) Pub. Date: Apr. 8, 2021

(54) PHONEME SOUND BASED CONTROLLER

(71) Applicant: Frédéric Borgeat, Gatineau (CA)

(72) Inventor: Frédéric Borgeat, Gatineau (Quebec) (CA)

(21) Appl. No.: 17/062,307

(22) Filed: Oct. 2, 2020

Related U.S. Application Data
(60) Provisional application No. 62/910,313, filed on Oct. 3, 2019.

(51) Int. Cl. G10L 15/02; G10L 25/27; G06N 20/00

(52) U.S. Cl. CPC G10L 15/02; G10L 25/27; G10L 2015/027; G10L 2015/025; G06N 20/00

(57) ABSTRACT

Disclosed herein is a phoneme sound based controller apparatus including: a sound input for receiving a sound signal; a phoneme sound detection module connected to the sound input to determine if at least one phoneme is detected in the sound signal; a dictionary containing at least one word, the word including at least one syllable, the syllable including the at least one phoneme; a grammar containing at least one rule, the at least one rule containing the at least one word, the at least one rule further containing at least one control action. At least one control action is taken if the at least one phoneme is detected in the sound input signal by the phoneme sound detection module. Other embodiments of this aspect include corresponding computer systems, apparatus, and computer programs recorded on one or more computer storage devices, each configured to perform the actions of the methods.

### CROSS-REFERENCE TO RELATED APPLICATIONS

This application is related to, and claims the benefit of priority from, U.S. Patent Application No. 62/910,313, filed on Oct. 3, 2019, entitled “PHONEME SOUND BASED CONTROLLER”, by Frédéric Borgeat.

### TECHNICAL FIELD

This application relates to voice recognition in general, and to a phoneme sound based controller, in particular.

### BACKGROUND OF THE APPLICATION

There are many applications for technology that recognizes the spoken word, with voice activated devices expected to be the next big disruptor in consumer technology. A specific area which may be in need of improvement however, is voice control, such as, for example in noisy environments and/or with false positives. There are reports of voice activated speakers and smart devices performing unexpected actions because they heard sound that was incorrectly interpreted as a voice control command In some circumstances, traditional voice controls can mistakenly hear control phrases. One known solution may be to change the control phrase to be another control phrase which is less likely to have false positives, and/or disabling the action that was originally to be voice controlled. Yet another solution may be to change the response from simply executing the command to asking the user to confirm the command before executing the command For at least these reasons, there may be a need for improvements in voice activated devices generally, and voice control specifically.

### SUMMARY

According to one aspect of the present application, there is provided a phoneme sound based controller. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a phoneme sound based controller apparatus, the apparatus including: a sound input for receiving a sound signal; a phoneme sound detection module connected to the sound input to determine if at least one phoneme is detected in the sound signal; a dictionary containing at least one word, the word including at least one syllable, the syllable including the at least one phoneme; a grammar containing at least one rule, the at least one rule containing the at least one word, the at least one rule further containing at least one control action. In the phoneme sound based controller apparatus at least one control action is taken if the at least one phoneme is detected in the sound input signal by the phoneme sound detection module. Other embodiments of this aspect include corresponding computer systems, apparatus, and computer programs recorded on one or more computer storage devices, each configured to perform the actions of the methods.

Implementations may include one or more of the following features. The apparatus according further including a detection output for providing a signal representing the determination by the phoneme sound detection module. The apparatus according further including a speech recognition engine connected to the sound input, the speech recognition engine providing a speech recognition context including the at least one word if the speech recognition engine recognizes the presence of the at least one word in the sound input. The apparatus according further including a result output, the result output including the at least one word if the detection output indicates that the at least one phoneme is detected in the input signal and the at least one word is recognized in the sound input. The apparatus according further including a result output, the result output including the at least one word if the detection output indicates that the at least one phoneme is detected in the input signal. The apparatus according where the phoneme sound detection module includes at least one phoneme sound attribute detection module to detect the presence of a predetermined phoneme sound attribute of the at least one phoneme in the sound signal. The apparatus according where the at least one phoneme sound attribute includes a frequency signature corresponding to the at least one phoneme. The apparatus according where the frequency signature includes an impulse frequency phoneme sound attribute. The apparatus according where the frequency signature includes a wideband frequency phoneme sound attribute. The apparatus according where the frequency signature includes a narrowband frequency phoneme sound attribute. The apparatus according where the at least one phoneme sound attribute includes at least one sound amplitude corresponding to the at least one phoneme. The apparatus according where the at least one phoneme sound attribute includes at least one sound phase corresponding to the at least one phoneme. The apparatus according further including at least one calibration profile including at least one phoneme attribute threshold value relative to which the at least one phoneme sound attribute detection module detects the presence of the predetermined phoneme sound attribute of the at least one phoneme in the sound signal. The apparatus according where the at least one phoneme sound attribute detection module determines that the predetermined phoneme sound attribute is greater than the at least one phoneme attribute threshold value. The apparatus according where the at least one phoneme sound attribute detection module determines that the predetermined phoneme sound attribute is less than the at least one phoneme attribute threshold value. The apparatus according where the at least one phoneme sound attribute detection module determines that the predetermined phoneme sound attribute is within a predetermined range relative to the at least one phoneme attribute threshold value. The apparatus according where the phoneme sound detection module is a composite phoneme sound detection module including at least two phoneme sound detection modules. The apparatus according where the phoneme sound detection module is a monolithic phoneme sound detection module. The apparatus according where the sound input includes at least one sound file. The apparatus according where the sound input includes at least one microphone. The apparatus according where the at least one phoneme includes a consonant sound phoneme. The apparatus according where the at least one phoneme includes a vowel sound phoneme. The apparatus according where the at least one phoneme includes a consonant digraph sound phoneme. The apparatus according where the at least one phoneme includes a short vowel sound phoneme. The apparatus according where the at least one phoneme includes a long vowel sound phoneme. The apparatus according where the at least one phoneme includes an other vowel sound phoneme. The apparatus according where the at least one phoneme includes a dipthong vowel sound phoneme. The apparatus according where the at least one phoneme includes a vowel sound influenced by r phoneme. The apparatus according where the dictionary includes at least one word selected from the following group of words: fast, slow, start or stop. The apparatus according where the at least one phoneme includes the /s/ phoneme. The apparatus according where the at least one control action includes an action to affect the speed of a metronome. Implementations of the described techniques may include hardware, a method or process, or computer software on a computer-accessible medium.

Other aspects and features of the present application will become apparent to those ordinarily skilled in the art upon review of the following description of specific embodiments of a phoneme sound based controller in conjunction with the accompanying drawing figures.

### BRIEF DESCRIPTION OF THE DRAWINGS

Embodiments of the present application will now be described, by way of example only, with reference to the accompanying drawing figures, wherein:

FIG. 1 is a block diagram of an exemplary application specific machine environment;

FIG. 2 is a block diagram of an exemplary collection of data representations;

FIG. 3 is a block diagram of an exemplary collection of data types;

FIG. 4 is a block diagram showing an example table of English Consonant Phonemes;

FIG. 5 is a block diagram showing an example table of English Vowel Phonemes;

FIG. 6 is a block diagram showing a broad aspect of a technique;

FIG. 7 is a block diagram of an exemplary class diagram structure of an application;

FIG. 8 is a signaling diagram of an exemplary portion of a Generic Application that provides a Specific Application having a sound spectrograph feature;

FIG. 9 is a block diagram illustrating an example Application Specific Grammar;

FIG. 10 is a block diagram showing a first specific example of the technique;

FIG. 11 is a block diagram showing a second specific example of the technique;

FIG. 12 is a block diagram showing a third specific example of the technique;

FIG. 13 is a block diagram showing a fourth specific example of the technique;

FIG. 14 is a diagram illustrating an example user interface for a voice controlled metronome Specific Application; and

FIG. 15 is a flowchart illustrating an example method.

Like reference numerals are used in different figures to denote similar elements.

### DETAILED DESCRIPTION OF THE DRAWINGS

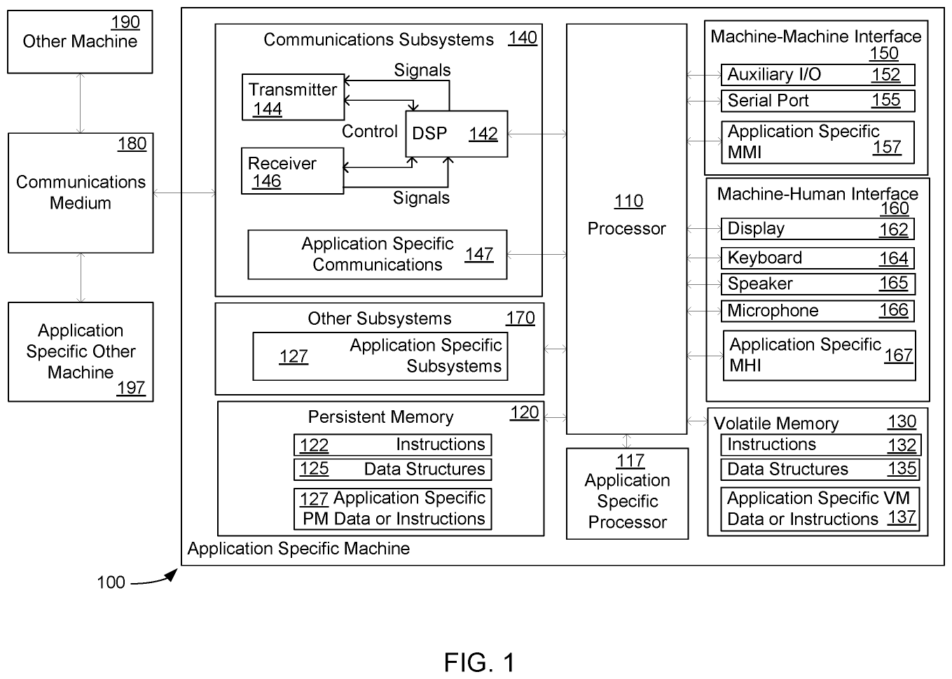

Referring to the drawings, Reference is now made to FIG. 1. FIG. 1 is a block diagram of an exemplary application specific machine environment that can be used with embodiments of the present application. Application Specific Machine 100 is preferably a two-way wireless or wired communication machine having at least data communication capabilities, as well as other capabilities, such as for example audio, and video capabilities. Application Specific Machine 100 preferably has the capability to communicate with other computer systems over a Communications Medium 180. Depending on the exact functionality provided, the machine may be referred to as a smart phone, a data communication machine, client, or server, as examples.

Where Application Specific Machine 100 is enabled for two-way communication, it will incorporate communication subsystem 140, including both a receiver 146 and a transmitter 144, as well as associated components such as one or more, preferably embedded or internal, antenna elements(not shown) if wireless communications are desired, and a processing module such as a digital signal processor (DSP) 142. As will be apparent to those skilled in the field of communications, the particular design of the communication subsystem 140 will be dependent upon the communications medium 180 in which the machine is intended to operate. For example, Application Specific Machine 100 may include communication subsystems 140 designed to operate within the 802.11 network, Bluetooth™ or LTE network, both those networks being examples of communications medium 180 including location services, such as GPS.

Communications subsystems 140 not only ensures communications over communications medium 180, but also application specific communications 147. An application specific processor 117 may be provided, for example to process application specific data, instructions, and signals, such as for example for GPS, near field, or other application specific functions such as digital sound processing. Depending on the application, the application specific processor 117 may be provided by the DSP 142, by the communications subsystems 140, or by the processor 110, instead of by a separate unit.

Network access requirements will also vary depending upon the type of communications medium 180. For example, in some networks, Application Specific Machine 100 is registered on the network using a unique identification number associated with each machine. In other networks, however, network access is associated with a subscriber or user of Application Specific Machine 100. Some specific Application Specific Machine 100 therefore require other subsystems 127 in order to support communications subsystem 140, and some application specific Application Specific Machine 100 further require application specific subsystems 127. Local or non-network communication functions, as well as some functions (if any) such as configuration, may be available, but Application Specific Machine 100 will be unable to carry out any other functions involving communications over the communications medium 1180 unless it is provisioned. In the case of LTE, a SIM interface is normally provided and is similar to a card-slot into which a SIM card can be inserted and ejected like a persistent memory card, like an SD card. More generally, persistent Memory 120 can hold many key application specific persistent memory data or instructions 127, and other instructions 122 and data structures 125 such as identification, and subscriber related information. Although not expressly shown in the drawing, such instructions 122 and data structures 125 may be arranged in a class hierarchy so as to benefit from re-use whereby some instructions and data are at the class level of the hierarchy, and some instructions and data are at an object instance level of the hierarchy, as would be known to a person of ordinary skill in the art of object oriented programming and design.

When required network registration or activation procedures have been completed, Application Specific Machine 100 may send and receive communication signals over the communications medium 180. Signals received by receiver 146 through communications medium 180 may be subject to such common receiver functions as signal amplification, frequency down conversion, filtering, channel selection and the like, analog to digital (A/D) conversion. A/D conversion of a received signal allows more complex communication functions such as demodulation and decoding to be performed in the DSP 142. In a similar manner, signals to be transmitted are processed, including modulation and encoding for example, by DSP 142 and input to transmitter 144 for digital to analog conversion, frequency up conversion, filtering, amplification and transmission over the communication medium 180. DSP 142 not only processes communication signals, but also provides for receiver and transmitter control. For example, the gains applied to communication signals in receiver 146 and transmitter 144 may be adaptively controlled through automatic gain control algorithms implemented in DSP 144. In the example system shown in FIG. 1, application specific communications 147 are also provided. These include communication of information located in either persistent memory 120 or volatile memory 130, and in particular application specific PM Data or instructions 127 and application specific PM Data or instructions 137.

Communications medium 180 may further serve to communicate with multiple systems, including an other machine 190 and an application specific other machine 197, such as a server (not shown), GPS satellite (not shown) and other elements (not shown). For example, communications medium 180 may communicate with both cloud based systems and a web client based systems in order to accommodate various communications with various service levels. Other machine 190 and Application Specific Other machine 197 can be provided by another embodiment of Application Specific Machine 100, wherein the application specific portions are either configured to be specific to the application at the other machine 190 or the application specific other machine 197, as would be apparent by a person having ordinary skill in the art to which the other machine 190 and application specific other machine 197 pertains.

Application Specific Machine 100 preferably includes a processor 110 which controls the overall operation of the machine. Communication functions, including at least data communications, and where present, application specific communications 147, are performed through communication subsystem 140. Processor 110 also interacts with further machine subsystems such as the machine-human interface 160 including for example display 162, digitizer/buttons 164 (e.g. keyboard that can be provided with display 162 as a touch screen), speaker 165, microphone 166 and Application specific HMI 167. Processor 110 also interacts with the machine-machine interface 1150 including for example auxiliary I/O 152, serial port 155 (such as a USB port, not shown), and application specific MHI 157. Processor 110 also interacts with persistent memory 120 (such as flash memory), volatile memory (such as random access memory (RAM)) 130. A short-range communications subsystem (not shown), and any other machine subsystems generally designated as Other subsystems 170, may be provided, including an application specific subsystem 127. In some embodiments, an application specific processor 117 is provided in order to process application specific data or instructions 127, 137, to communicate application specific communications 147, or to make use of application specific subsystems 127.

Some of the subsystems shown in FIG. 1 perform communication-related functions, whereas other subsystems may provide application specific or on-machine functions. Notably, some subsystems, such as digitizer/buttons 164 and display 162, for example, may be used for both communication-related functions, such as entering a text message for transmission over a communication network, and machine-resident functions such as application specific functions.

Operating system software used by the processor 110 is preferably stored in a persistent store such as persistent memory 120 (for example flash memory), which may instead be a read-only memory (ROM) or similar storage element (not shown). Those skilled in the art will appreciate that the operating system instructions 132 and data 135, application specific data or instructions 137, or parts thereof, may be temporarily loaded into a volatile 130 memory (such as RAM). Received or transmitted communication signals may also be stored in volatile memory 130 or persistent memory 120. Further, one or more unique identifiers (not shown) are also preferably stored in read-only memory, such as persistent memory 120.

As shown, persistent memory 120 can be segregated into different areas for both computer instructions 122 and application specific PM instructions 127 as well as program data storage 125 and application specific PM data 127. These different storage types indicate that each program can allocate a portion of persistent memory 120 for their own data storage requirements. Processor 110 and when present application specific processor 117, in addition to its operating system functions, preferably enables execution of software applications on the Application Specific Machine 100. A predetermined set of applications that control basic operations, including at least data communication applications for example, will normally be installed on Application Specific Machine 100 during manufacturing. A preferred software application may be a specific application embodying aspects of the present application. Naturally, one or more memory stores would be available on the Application Specific Machine 100 to facilitate storage of application specific data items. Such specific application would preferably have the ability to send and receive data items, via the communications medium 180. In a preferred embodiment, the application specific data items are seamlessly integrated, synchronized and updated, via the communications medium 180, with the machine 110 user's corresponding data items stored or associated with an other machine 190 or an application specific other machine 197. Further applications may also be loaded onto the Application Specific Machine 100 through the communications subsystems 140, the machine-machine interface 150, or any other suitable subsystem 170, and installed by a user in the volatile memory 130 or preferably in the persistent memory 120 for execution by the processor 110. Such flexibility in application installation increases the functionality of the machine and may provide enhanced on-machine functions, communication-related functions, or both. For example, secure communication applications may enable electronic commerce functions and other such financial transactions to be performed using the Application Specific Machine 100.

In a data communication mode, a received signal such as a text message or web page download will be processed by the communication subsystem 140 and input to the processor 110, which preferably further processes the received signal for output to the machine-human interface 160, or alternatively to a machine-machine interface 150. A user of Application Specific Machine 100 may also compose data items such as messages for example, using the machine-human interface 1160, which preferably includes a digitizer/buttons 164 that may be provided as on a touch screen, in conjunction with the display 162 and possibly a machine-machine interface 150. Such composed data items may then be transmitted over a communication network through the communication subsystem 110. Although not expressly show, a camera can be used as both a machine-machine interface 150 by capturing coded images such as QR codes and barcodes, or reading and recognizing images by machine vision, as well as a human-machine interface 160 for capturing a picture of a scene or a user.

For audio/video communications, overall operation of Application Specific Machine 100 is similar, except that received signals would preferably be output to a speaker 134 and display 162, and signals for transmission would be generated by a microphone 136 and camera (not shown). Alternative voice or audio I/O subsystems, such as a voice message recording subsystem, may also be implemented on Application Specific Machine 100. Although voice or audio signal output is preferably accomplished primarily through the speaker 165, display 162 and applications specific MHI 167 may also be used to provide other related information.

Serial port 155 in FIG. 1 would normally be implemented in a smart phone-type machine as a USB port for which communication or charging functionality with a user's desktop computer, car, or charger (not shown), may be desirable. Such a port 155 would enable a user to set preferences through an external machine or software application and would extend the capabilities of Application Specific Machine 100 by providing for information or software downloads to Application Specific Machine 100 other than through a communications medium 180. The alternate path may for example be used to load an encryption key onto the machine through a direct and thus reliable and trusted connection to thereby enable secure machine communication.

Communications subsystems 140, may include a short-range communications subsystem (not shown), as a further optional component which may provide for communication between Application Specific Machine 100 and different systems or machines, which need not necessarily be similar machines. For example, the other subsystems 170 may include a low energy, near field, or other short-range associated circuits and components or a Bluetooth™ communication module to provide for communication with similarly enabled systems and machines.

The exemplary machine of FIG. 1 is meant to be illustrative and other machines with more or fewer features than the above could equally be used for the present application. For example, one or all of the components of FIG. 1 can be implemented using virtualization whereby a virtual Application Specific Machine 100, Communications medium 180, Other machine 190 or Application Specific Other Machine 197 is provided by a virtual machine. Software executed on these virtual machines is separated from the underlying hardware resources. The host machine is the actual machine on which the virtualization takes place, and the guest machine is the virtual machine. The terms host and guest differentiate between software that runs on the physical machine versus the virtual machine, respectively. The virtualization can be full virtualization wherein the instructions of the guest or virtual machine execute unmodified on the host or physical machine, partial virtualization wherein the virtual machine operates on shared hardware resources in an isolated manner, to hardware-assisted virtualization whereby hardware resources on the host machine are provided to optimize the performance of the virtual machine. Although not expressly shown in the drawing, a hypervisor program can be used to provide firmware for the guest or virtual machine on the host or physical machine. It will be thus apparent to a person having ordinary skill in the art that components of FIG. 1 can be implemented in either hardware or software, depending on the specific application. For example, while testing and developing the Application Specific Machine 100 may be provided entirely using an emulator for the machine, for example a smartphone emulator running Android™ or iOS™. When deployed, real smartphones would be used.

Each component in FIG. 1 can be implemented using any one of a number of cloud computing providers such as Microsoft's Azure™, Amazon's Web Service™, Google's Cloud Computing, or an OpenStack based provider, by way of example only. Thus, as will be apparent to a person having ordinary skill in the relevant field of art, depending on whether the environment in which operate the components of FIG. 1, the Communications medium 180 can be the Internet, an IP based medium such as a virtual, wired, or wireless network, an interconnect back plane on a host machine serving as a back bone between virtual machines and/or other real machines, or a combination thereof. For example, in the case of the communications subsystems 140, the Transmitter 144, Receiver 146 and DSP 142 may be unnecessary if the application specific machine is provided as a virtual machine. Likewise, when the application is a server provided as a virtual machine, the machine-human interface 160 and machine-machine interface 150 may be provided by re-use of the resources of the corresponding host machine, if needed at all.

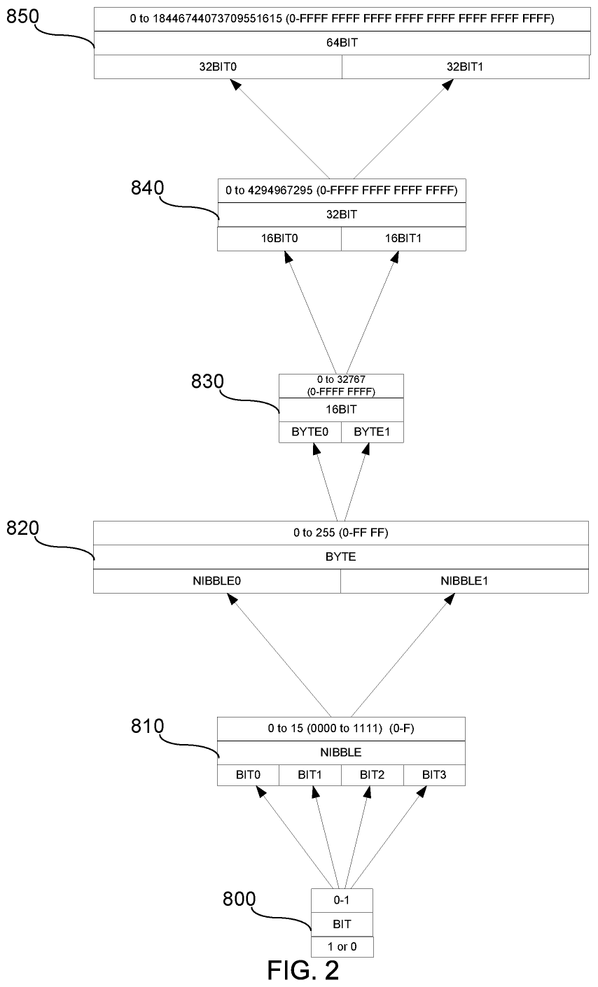

FIG. 2 is a block diagram of an exemplary collection of data representations for a bit, a nibble, a byte, a 16 bit, a 32 bit and a 64 bit values. A bit 800 is a binary data structure that can take on one of two values, typically represented by a 1 or a 0. In alternative physical realizations of a bit, the bit can be stored in read only memory, random access memory, storage medium, electromagnetic signals. Bits are typically realized in large multiples to represent vast amounts of data. A grouping four bits is called a nibble 810. Two nibbles form a bye 820. The byte 820 is of particular importance as most data structures that are larger groupings of bits than one byte are typically made up of multiples of bytes. Two bytes form 1 16 BIT 830 structure. Two 16 BIT structures form a 32 BIT 840 structure. Two 32 BIT structures form a 64 BIT 750 structure.

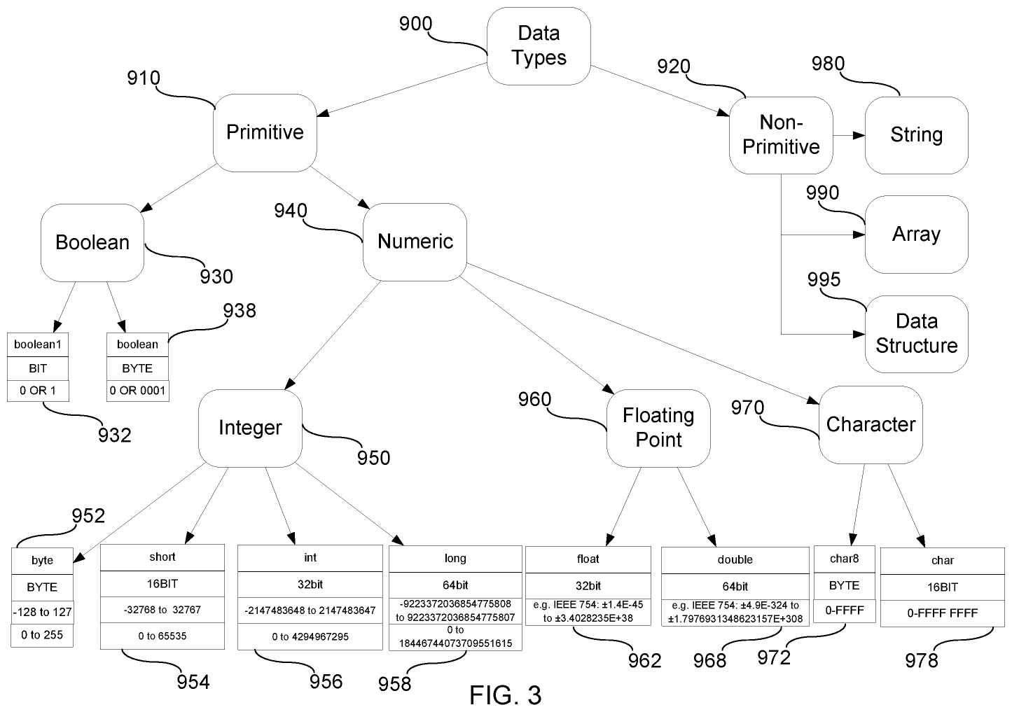

Figure. 3 is a block diagram of an exemplary collection of data types that uses the data representations of FIG. 2. Data types 900 are abstractions that represent application specific data using either primitive 910 or non-primitive constructs 920 The most fundamental primitive data type is a Boolean 930 data type, which can be represented using a single bit with the booleanl 932 data structure, or more frequently using a boolean 938 data structure that uses a single byte. More complex data types of the primitive data type is a Numeric 940 data type. Three broad examples of the Numeric 940 data type are the Integer 950 data type, the Floating Point 960 data type, and the Character 970 data types. A byte 952, a short 964, an int 966, and a long 968 are examples of Integer 950 Numeric 940 Primitive 910 Data Types 900 using a BYTE, 16 BIT, 16 BIT, 32 BIT and 64 BIT representation respectively. A float 962 and a double 968 are examples of Floating Point 960 Numeric 940 Primitive 910 Data Types and are represented using 32 BIT and 64 BIT representations respectively. Depending on the application, Integer 950 and Floating Point 960 Data Types 900 can be interpreted as signed or unsigned values. In contrast, Character 980 data types represent alphanumeric information. A char8 972 is represented using a single byte, while a char 978 is represented using a 16 BIT value, such as for example in ASCII or Unicode respectively. Having defined some example Primitive 910 Data Types 900, it is possible to build up Non-Primitive 920 Data Types 900 by combining Primitive 910 ones, such as for example a String 980 which is a collection of consecutive Character 970, an Array which is a collection of Primitive 910, and more generally, a Data Structure 995 which can be a collection of one or more Data Types 900.

Having described the environment in which the specific techniques of the present application can operate, application specific aspects will be further described by way of example only.

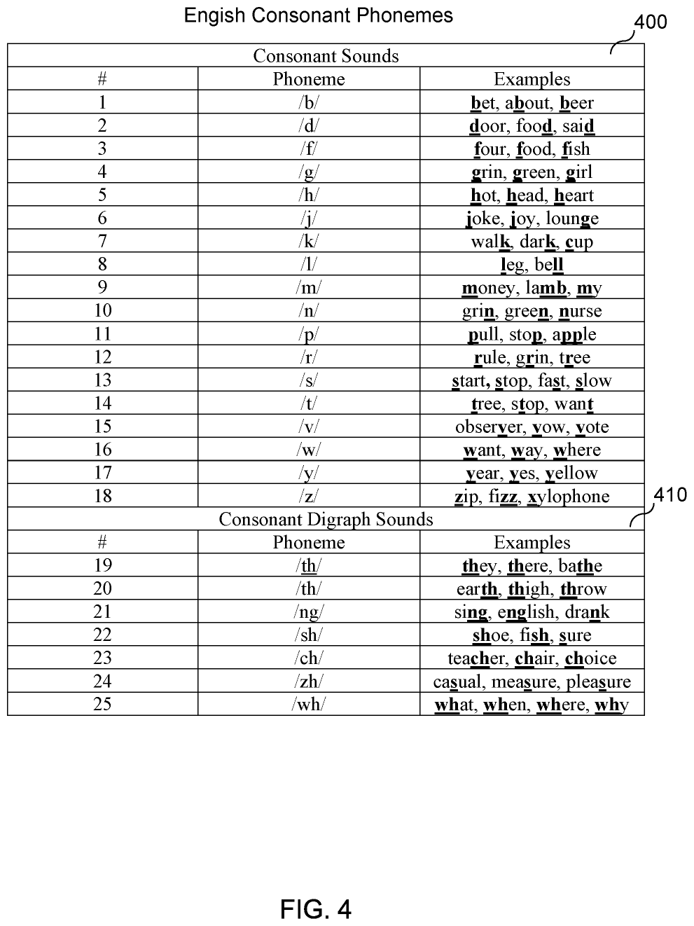

FIG. 4 is a block diagram showing an example table of English Consonant Phonemes, provided in accordance with an embodiment of the present application. As illustrated, the example English Consonant Phonemes table includes two types of Phonemes, Consonant Sounds 400, including Phonemes #1-18, and Consonant Digraph Sounds 410, including Phonemes #19-25. The consonant sounds illustrated are for the English language as an example only. A person of ordinary skill in the art would be able to use phoneme tables of another language than English, and the use of phonemes from other languages is considered by the applicant to be within the scope and the teachings of the present application. For example, phoneme #13, illustrated with the symbol /s/ represents the “s” sound, as illustrated in the example words start, stop, fast, and slow in English. However, this phoneme can be found in several languages, such as French, Spanish, etc.

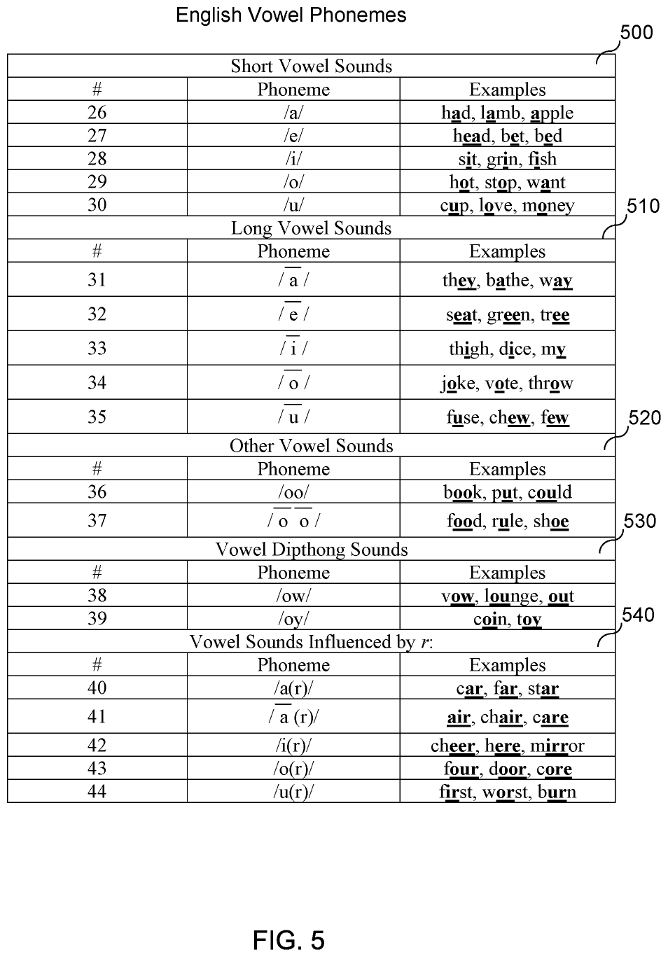

FIG. 5 is a block diagram showing an example table of English Vowel Phonemes, provided in accordance with an embodiment of the present application. As illustrated, the example English Vowel Phonemes table includes five types of Phonemes, Short Vowel Sounds 500, including Phonemes #26-30, Long Vowel Sounds 510, including Phonemes #31-35, Other Vowel Sounds 510, including Phonemes #36-37, Vowel Dipthong Sounds 520, including Phonemes #38-39 530, and Vowel Sounds Influenced by r 540, including Phonemes #40-44. The vowel sounds illustrated are for the English language as an example only. A person of ordinary skill in the art would be able to use phoneme tables of another language than English, and the use of phonemes from other languages is considered by the applicant to be within the scope and the teachings of the present application.

Words are the smallest meaningful unit of a language, and are made of syllables. Syllables in turn, include only one vowel phoneme. Words are therefore clusters of syllables, each syllable including at least one vowel phoneme, and possibly one or more consonant phonemes. For example, the words start, stop, fast and slow only have one syllable each because they each only have one vowel phoneme. They each also have at least one consonant phoneme, specifically the /s/ phoneme. The fact that all these words have at least one phoneme in common can be used advantageously to help differentiate between the voice recognition of each of these words in non-ideal (e.g. noisy) environments, as will be explained in greater detail below. Phonemes are units of sound used by a language speaking community, and there pronunciation varies from community to community, and even from different individuals within a community Such variations can be mitigated through calibration of the specific phonemes that are relevant to words for a given application, as will also be explained in greater detail below.

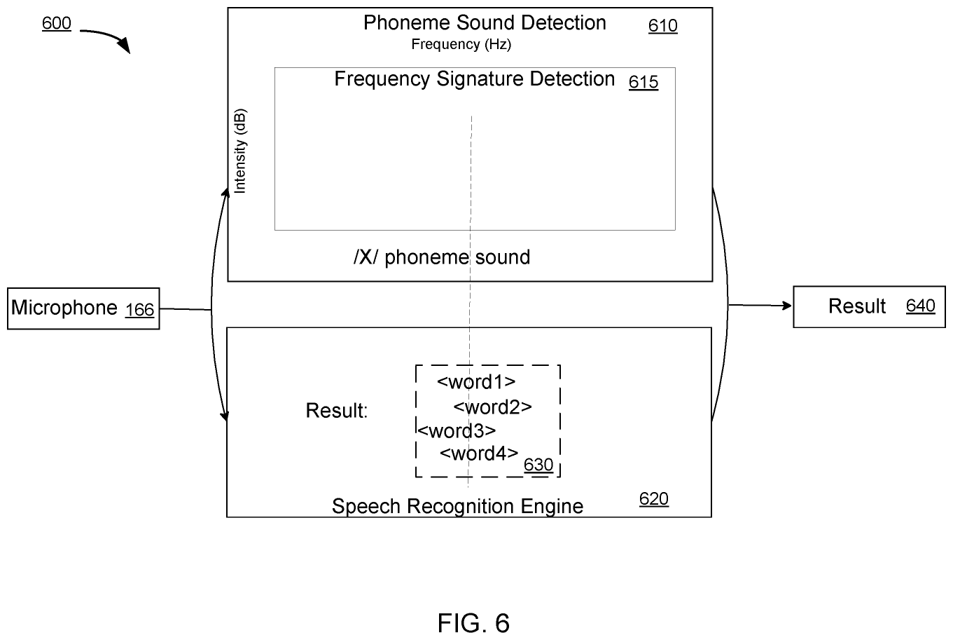

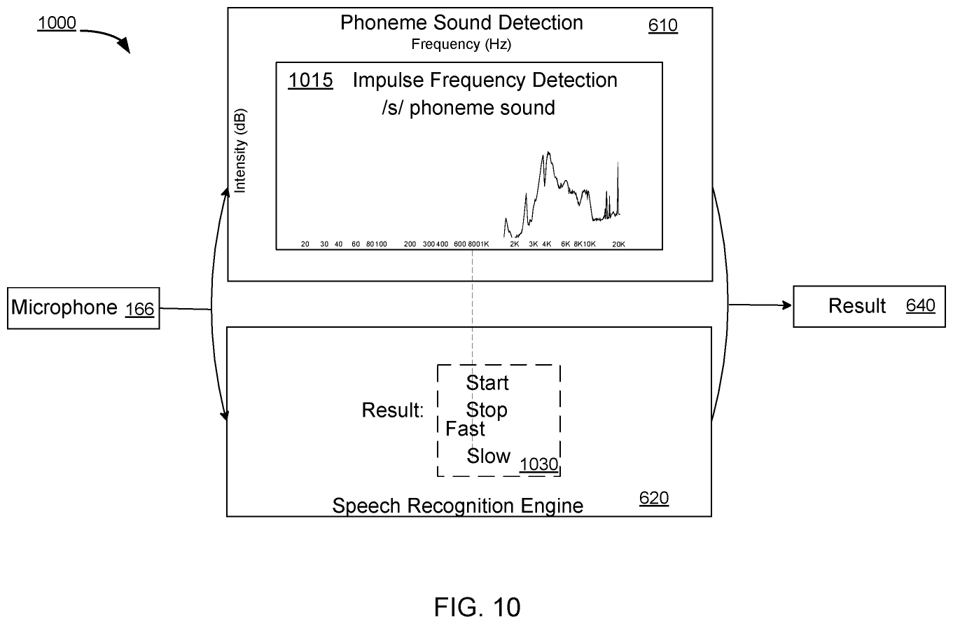

FIG. 6 is a block diagram showing a broad aspect of a technique, provided in accordance with an embodiment of the present application. As illustrated in the block diagram 600, illustrates a microphone 166, a Phoneme Sound Detection block 610, a Speech Recognition Engine block 620, and a Result block 240. The microphone 166 is used to listen for audio input. Advantageously, the audio input is processed using two different techniques, first in the Speech Recognition Engine 620, and second in the Phoneme Sound Detection 610, and only when both techniques concur, will a result be obtained. For example, words 630 including for example each of word1, word2, word3 and word4 can be detected in the Speech Recognition Engine 620. However, unless one of those words includes a phoneme that is detected by the Frequency Signature Detection block 615 of the Phoneme Sound Detection block 610, that word is not provided in the Result block 640. This ensures that only a select group of words having a select group of phonemes are recognized and validated. Further details of this validation aspect will be described further in relation to a more specific example in FIGS. 10-13.

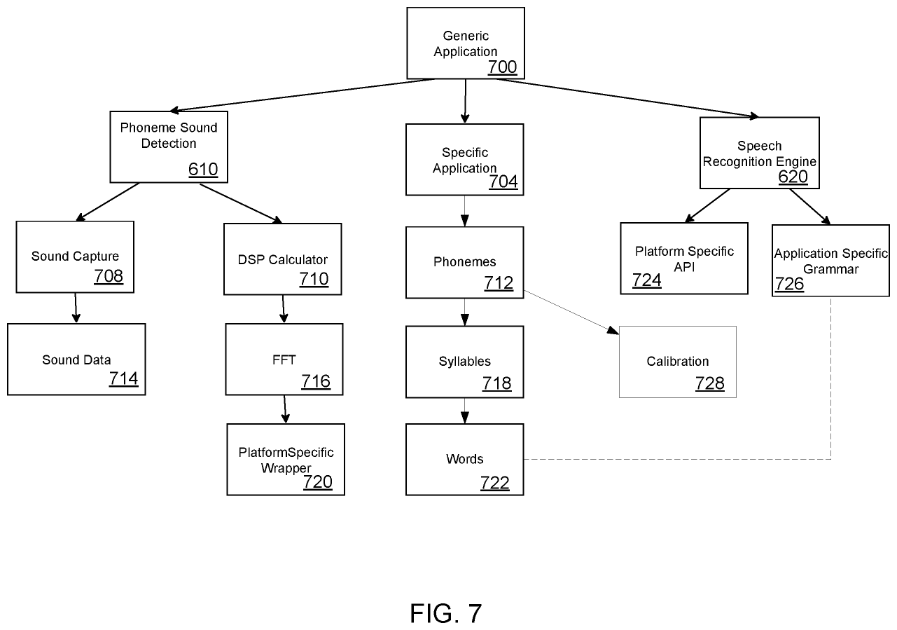

Figure. 7 is a block diagram of an exemplary class diagram structure of an application, provided in accordance with the present application. As illustrated, the block diagram includes Generic Application 700, Phoneme Sound Detection 610 (e.g. Sound Frequency Bandwidth Detection), Specific Application 704, Sound Capture 708, DSP Calculator 710, Phonemes 712, Calibration 728, Sound Data 714, FFT 716 (Fast Fourier Transform), Syllables 718, Platform Specific Wrapper 720, Words 722, Speech Recognition Engine 620, Platform Specific API 724, and Application Specific Grammar 726. The Generic Application 700 includes all of the steps and techniques that can be reused across various Specific Application 704, in other words, it provides a generic framework for validating an Application Specific Grammar 726 made up of Words 722 that are arranged according to an application specific syntax (not shown for the generic application, see later figures for an example). The Words 722 in turn are made up of Syllables 718, which are in turn made up of Phonemes 712. The Phonemes 712 are optionally subject of a Calibration 728 to mitigate the differences in pronunciation by different communities and individuals, and in different languages.

The Specific Application 704 provides the end goal that is to be realized by the framework, such as for example, a voice controlled metronome, as will be described later. The Speech Recognition Engine 620 uses the Application Specific Grammar 726 abstractly and implements the necessary calls to a Platform Specific API 724, such as for example the Speech Recognition Engine in Microsoft Windows™, Android™, iOS™, or the like. The Phonemes 712 and their optional Calibration 728 are used by the Frequency Bandwidth Detection 610 in order to detect a pulse corresponding to the Phonemes 712. Syllables 718 relate Phonemes 718 to Words 722 and the Application Specific Grammar 726. Thus, even though Speech Recognition Engine 620 recognizes one of the Words 722, this is not considered a valid recognition by the controller unless the Frequency Bandwidth Detection 610 detects an impulse corresponding to at least one Phonemes 712 that is related to the said one of the Words 722, thereby advantageously avoiding false positives in e.g. a noisy environment, such as for example during a music session for a metronome Specific Application 704. Operationally, Sound Capture 708 captures Sound Data 714 that is used by DSP Calculator 710 (that uses the DSP 142 or Application Specific Processor 117 for example) and FFT 716 to detect an impulse corresponding to the Phonemes 712. The Platform Specific Wrapper 720, similarly to the Platform Specific API 724, ensures that the Generic Application 700, and the Specific Application 704, can be easily ported to different platforms. A preferred way of achieving this is to realize these Platform Specific elements using Wrapper classes that abstract away the platform specific dependencies.

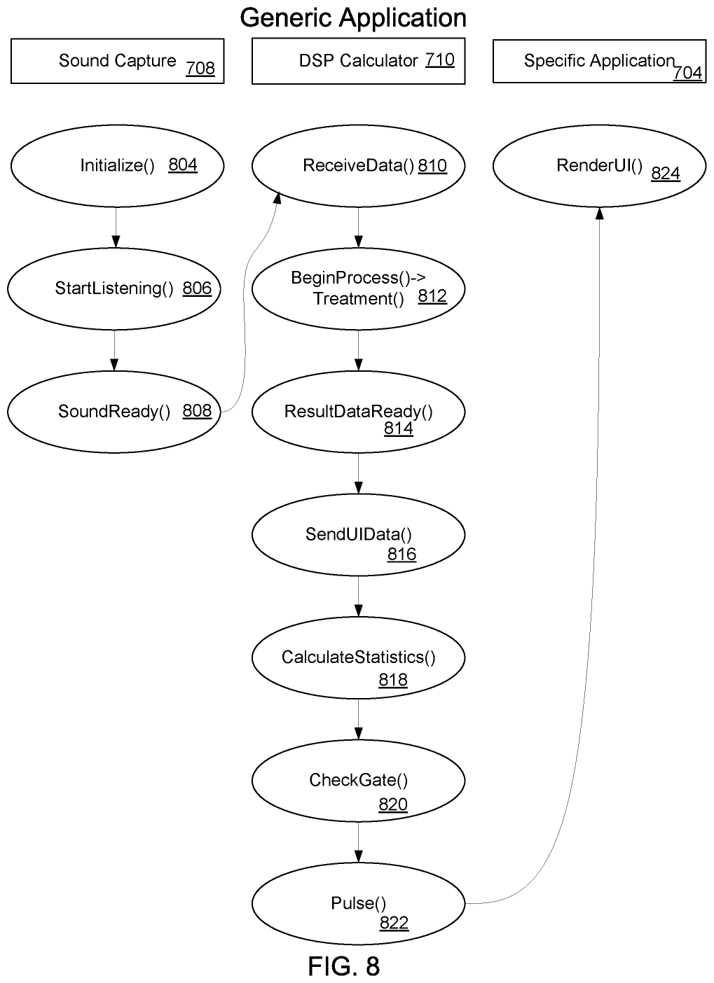

FIG. 8 is a signaling diagram of an exemplary portion of a Generic Application that provides a Specific Application having a sound spectrograph feature, provided in accordance with the present application. The steps are shown in sequential form, but in many cases the steps can occur in parallel. The Sound Capture block 800 is responsible for the steps of Initialize( ) 804 whereat the acts necessary to use the microphone to collect Sound Data 714 are taken, StartListening( ) 806 whereat the acts necessary to collect the Sound Data 714 are taken, and SoundReady( ) 808 whereat the Sound Data 714 has been collected and is ready to be further processed. This is signaled to the DSP Calculator block 710 which is responsible for the steps of ReceiveData( ) 810 whereat the Sound Data 714 is received from the Sound Capture 708, the BeginProcess( )→Treatment( ) 812 step whereat the act of processing the Sound Data 714 to calculate a sound spectrograph suitable for display as well as averages for peak detection are taken, the ResultDataReady( ) 814 step whereat the previous step is completed, the SendUIData( ) 816 step whereat the sound spectrograph data is sent to be displayed in the UI (User Interface) of the Specific Application 704, the CalculateStatistics( ) 818 step whereat a number of bins, e.g. 11 bins, are used to calculate averages corresponding to specific frequencies that are relevant to specific bandwidths and Phonemes (e.g. bins of relevance to the /s/ Phoneme, /t/ Phoneme, /p/ Phoneme, /t/ Phoneme, etc. . . . ), the CheckGate( ) 820 whereat the values of interest are compared to predetermined thresholds (optionally determined through Calibration or default values), and the Pulse( ) 822 step whereat if the Phoneme(s) are detected a Boolean true signal is set for a fixed interval of time, e.g. 7 ms, to allow for the synchronization between the Speech Recognition Engine 620 and the Frequency Bandwidth Detection 610 by the Generic Application 700 and ultimately the Specific Application 704. The Specific Application 704 is responsible for the RenderUI( ) 824 step whereat the sound spectrograph is displayed, and any other actions that are application specific can be taken in response to the Pulse( ) 822 signal. A detailed example follows with respect to a voice controlled metronome specific application.

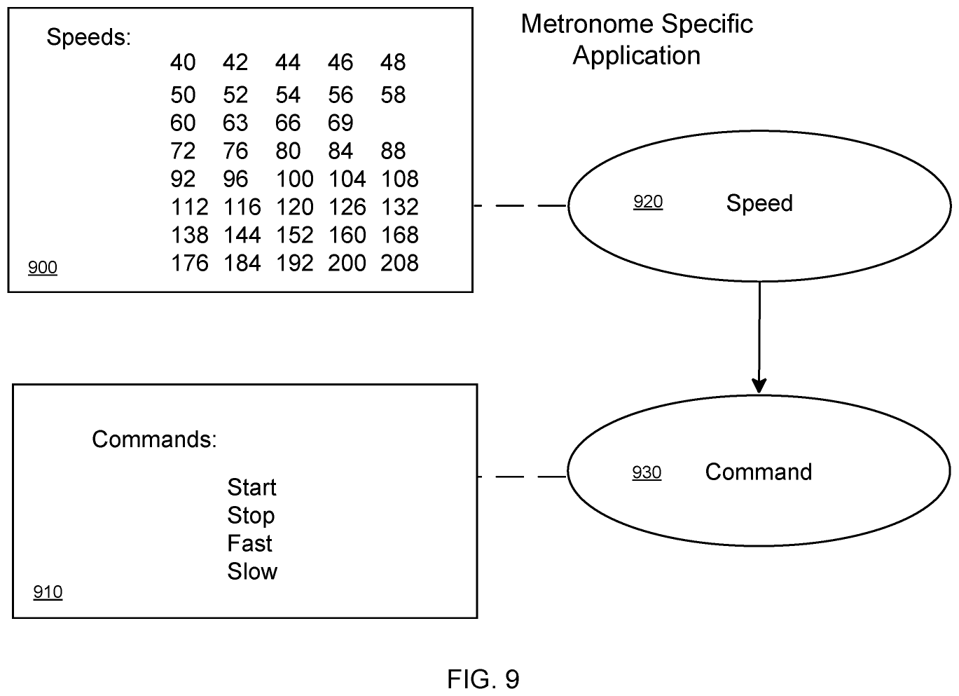

FIG. 9 is a block diagram illustrating an example Application Specific Grammar for a voice controlled metronome Specific application provided in accordance with the present application. The grammar includes a Speed 920 selected from a group of predetermined Speeds 900, and a Command 930 selected from a group of predetermined Commands 910. The example predetermined Speeds, in beats per minute, ranging from 40 to 208 are those that are often found in typical metronomes. By limiting the speeds to a predetermined number, this has the advantage of limiting the number of possible words that need to be recognized The predetermined Commands 910 include Start, Stop, Fast, Slow—all of which have the advantage of being single syllable words having the /s/ Phoneme.

FIG. 10 is a block diagram showing a first specific example of the technique of FIG. 6, provided in accordance with an embodiment of the present application. As illustrated in the block diagram 1000, there is shown a microphone 166, a Phoneme Sound Detection 610 (including e.g. for the /s/ phoneme sound Impulse Frequency Detection 1015), a Speech Recognition Engine block 620, and a Result block 640. The microphone 166 is used to listen for audio input. Advantageously, the audio input is processed using two different techniques, first in the Speech Recognition Engine 620, and second in the Impulse Frequency Detection 1015 of the Phoneme Sound Detection 610, and only when both techniques concur, will a result be obtained. For example, words 1030 can be detected in the Speech Recognition Engine 620. Advantageously, when a word 1030 detected by the Speech Recognition Engine 620 includes a phoneme such as for example /s/ (e,g, Start, Stop, Fast and Slow) that is detected by the Impulse Frequency Detection block 1015 of the Phoneme Sound Detection block 610, that word is provided in the Result block 640. This ensures that only a select group of words, Commands 910 having a select group of phonemes, as shown in the figure e.g. /s/, are recognized and validated, which is particularly advantageous in noisy environments.

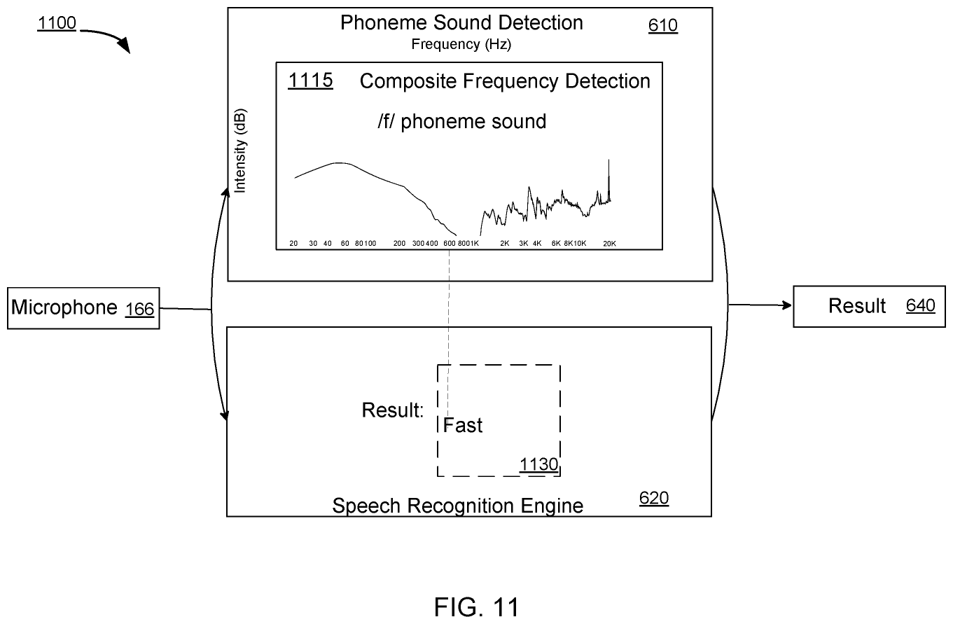

FIG. 11 is a block diagram showing a second specific example of the technique of FIG. 6, provided in accordance with an embodiment of the present application. In this figure, the Phoneme Sound Detection block 610 includes a Composite Frequency Detection 1115 for detecting a phoneme having two frequency signatures e.g. /f/ phoneme sound that is composed of a first frequency signature in a lower band, and a second frequency signature in a higher band. Advantageously, when a word 1130 detected by the Speech Recognition Engine 60 includes a phoneme such as for example /f/ (e,g, Fast) that is detected by the Composite Frequency Detection block 1015 of the Phoneme Sound Detection block 610, that word is provided in the Result block 640.

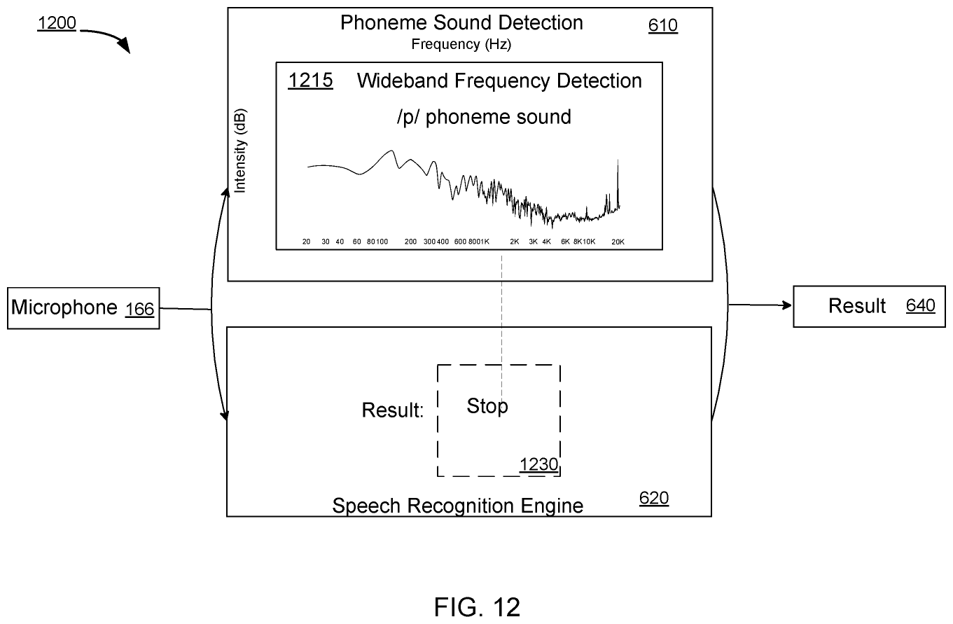

FIG. 12 is a block diagram showing a third specific example of the technique of FIG. 6, provided in accordance with an embodiment of the present application. In this figure, the Phoneme Sound Detection block 610 includes a Wideband Frequency Detection 1215 for detecting a phoneme having a wide frequency signatures e.g. /p/ phoneme sound that extends from a lower band to a higher band. Advantageously, when a word 1130 detected by the Speech Recognition Engine 620 includes a phoneme such as for example /p/ (e,g, Stop) that is detected by the Wideband Frequency Detection block 1215 of the Phoneme Sound Detection block 610, that word is provided in the Result block 640.

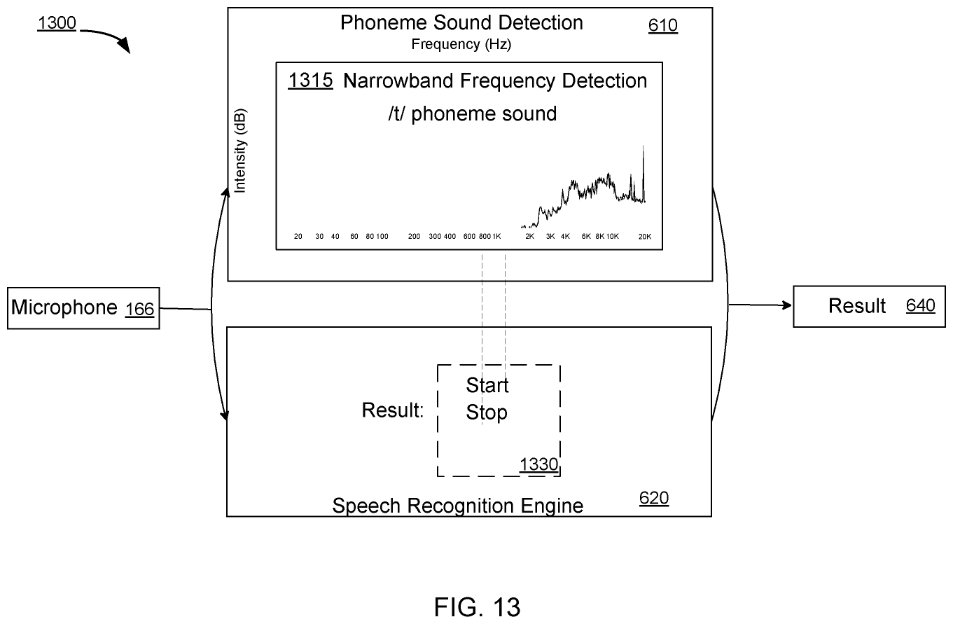

FIG. 13 is a block diagram showing a fourth specific example of the technique of FIG. 6, provided in accordance with an embodiment of the present application. In this figure, the Phoneme Sound Detection block 610 includes a Narrowband Frequency Detection 1215 for detecting a phoneme having a narrow frequency signatures e.g. /t/ phoneme sound that extends from a first frequency to a second frequency within a narrow band. Advantageously, when a word 1130 detected by the Speech Recognition Engine 620 includes a phoneme such as for example /p/ (e,g, Stop) that is detected by the Wideband Frequency Detection block 1215 of the Phoneme Sound Detection block 610, that word is provided in the Result block 640.

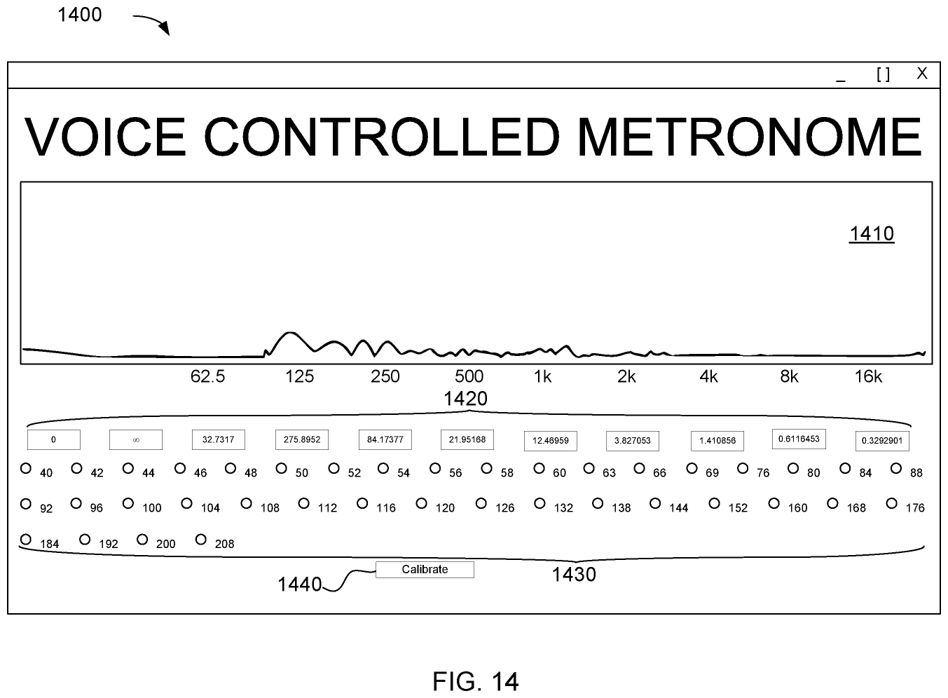

FIG. 14 is a diagram illustrating an example user interface for a voice controlled metronome Specific Application provided in accordance with the present application. User interface 1400 includes user interface elements that illustrate the technique when applied to control a metronome Specific Application using voice commands, the user interface elements being updated, for example, using the signaling of FIG. 8. The user interface 1400 elements includes speed indicator elements 1430, which as illustrated range from 40 to 208 beats per minute, in the intervals most commonly found in traditional non-voice controlled metronomes, and that correspond to the speeds specified in the Speeds block 900 of FIG. 9. As voice commands are processed by the technique, if commands conform the the grammar specified in FIG. 9, the speed indicator elements will display the corresponding speed of the metronome. Although not expressly shown in the drawing, a sound output (e.g. speaker, ear piece, sound file, sound track, back track, or click track) outputs a tick at the specified speed. Optional spectrograph 1410 shows the frequency response of the sound being captured through the sound input. An optional Calibrate button 1440 shows a means for the user can be prompted to speak specific words to calibrate the Phoneme Sound Detection module for the specific grammar In one embodiment, the only Phoneme that needs to be detected is the /s/ Phoneme such that the calibration procedure only requires the user to make the /s/ phoneme sound to establish a threshold for comparison purposes during operation. More generally, multiple phonemes can be sampled to account for differences in pronunciation of an individual user or dialect of a specific community

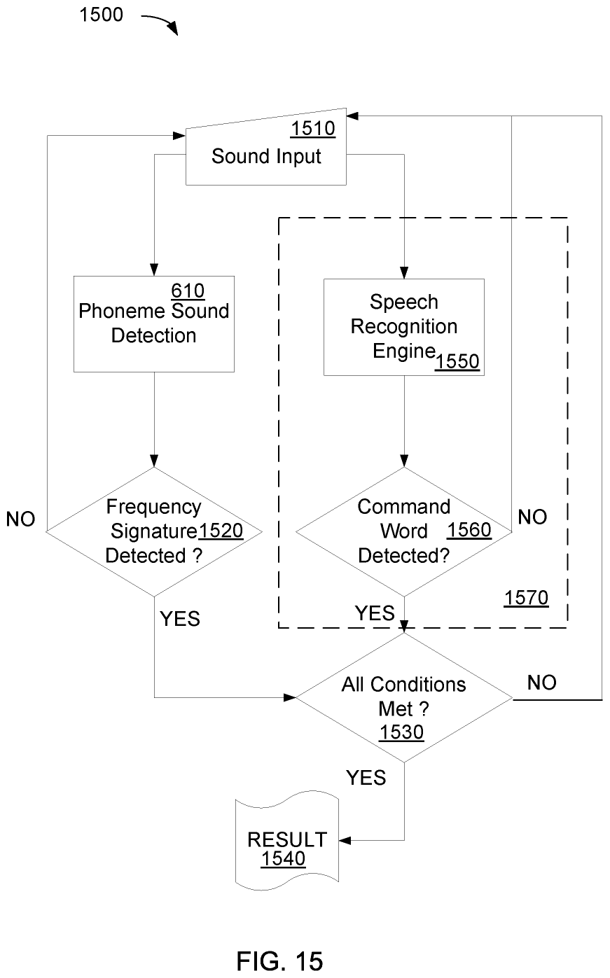

FIG. 15 is a flowchart illustrating an example method provided in accordance with the present application. Flowchart 1500 shows Sound Input 1510, Phoneme Sound Detection 610, Frequency Signature Detected step 1520, Result 1540, Speech Recognition Engine 1550, Command Word Detected step 1560, and optional block 1570. Operationally, the sound input 1510 is directed to the Phoneme Sound Detection 610 whereat the presence of at least one phoneme is determined. At step 1520, if a Frequency Signature is Detected for the at least one phoneme, and if all conditions are met at step 1530, then and only then is a Result 1540 provided. Conditions include, for example, that more than one frequency signature has been detected either directly or indirectly, for example, by process of elimination

For example, consider the commands Start, Stop, Fast and Slow (in the metronome example the speeds commands can be optional as long as speeds are limited to the values shown, and the initial speed has a default starting value). “Slow” is provided as a result if the detection of the /s/ Phoneme and the absence of the /t/, /p/ and /f/ Phonemes in the Phoneme Sound Detection 610 is determined, as follows. If an /s/ Phoneme is detected, then possible results include Start Stop Fast or Slow. If an /s/ and /f/ phoneme are detected, then the result is Fast. If an /s/ and /p/ phoneme are detected, then the result is Stop. If the /s/ Phoneme is detected and none of the /t/, /p/ and /f/ phonemes are detected, then the result is Slow. The table below illustrates this Boolean logic:

| /s/ | /t/ | /p/ | /f/ | Result |
|---|---|---|---|---|
| 0 | 0 | 0 | 0 | X |
| 0 | 0 | 0 | 1 | X |
| 0 | 0 | 1 | 0 | X |
| 0 | 0 | 1 | 1 | X |
| 0 | 1 | 0 | 0 | X |
| 0 | 1 | 0 | 1 | X |
| 0 | 1 | 1 | 0 | X |
| 0 | 1 | 1 | 1 | X |
| 1 | 0 | 0 | 0 | S l o w |
| 1 | 0 | 0 | 1 | X |
| 1 | 0 | 1 | 0 | X |
| 1 | 0 | 1 | 1 | X |
| 1 | 1 | 0 | 0 | S t a r t |
| 1 | 1 | 0 | 1 | F a s t |
| 1 | 1 | 1 | 0 | S t o p |
| 1 | 1 | 1 | 1 | X |

As this example shows, by combining the right phoneme signature detection blocks and Boolean logic in the Phoneme Sound Detection block, the need for the speech recognition engine 1550 can be eliminated. If however the speech recognition engine 1550 is used, optional blocks 1570 are present, then an additional condition at step 1560 that the command word is detected can be considered at step 1530. Although not expressly shown in the drawing, sound input 1510 could be redirected from any sound source, including a microphone, sound file or sound track. At Result 1540, a corresponding action can be taken.

Although not expressly shown in the drawings, in alternative embodiments, the speech recognition engine uses an ASR (Automatic Speech Recognition) system that uses ML (machine learning) to improve its accuracy, by adapting the ASR with the following steps: (1) providing a welcome message to the user, to explain that their recordings will be used to improve the ASR's acoustic model; (2) providing a confirmation button or check box or the like to enable the user to give their consent; (3) looking up the next speech occurrence that has not been captured yet and presenting it to the user; (4) recording as the occurrence is being spoken by the user; (5) automatically sending the audio data to a predetermined directory; (6) enabling a person to review the audio data manually before including it in the ASR's ML mechanism; and (7) marking the recording for this occurrence for this user as processed.

The embodiments described herein are examples of structures, systems or methods having elements corresponding to elements of the techniques of this application. This written description may enable those skilled in the art to make and use embodiments having alternative elements that likewise correspond to the elements of the techniques of this application. The intended scope of the techniques of this application thus includes other structures, systems or methods that do not differ from the techniques of this application as described herein, and further includes other structures, systems or methods with insubstantial differences from the techniques of this application as described herein. Those of skill in the art may effect alterations, modifications and variations to the particular embodiments without departing from the scope of the application, which is set forth in the claims

What is claimed is:

1. A phoneme sound based controller apparatus, the apparatus comprising:
(a) a sound input for receiving a sound signal;
(b) a phoneme sound detection module connected to the sound input to determine if at least one phoneme is detected in the sound signal;
(c) a dictionary containing at least one word, the word comprising at least one syllable, the syllable comprising the at least one phoneme;
(d) a grammar containing at least one rule, the at least one rule containing the at least one word, the at least one rule further containing at least one control action;
wherein the at least one control action is taken if the at least one phoneme is detected in the sound input signal by the phoneme sound detection module.

2. The apparatus according to claim 1, further comprising a detection output for providing a signal representing the determination by the phoneme sound detection module.

3. The apparatus according to claim 2, further comprising a speech recognition engine connected to the sound input, the speech recognition engine providing a speech recognition context including the at least one word if the speech recognition engine recognizes the presence of the at least one word in the sound input.

4. The apparatus according to claim 3, further comprising a result output, the result output including the at least one word if the detection output indicates that the at least one phoneme is detected in the input signal and the at least one word is recognized in the sound input.

5. The apparatus according to claim 2, further comprising a result output, the result output including the at least one word if the detection output indicates that the at least one phoneme is detected in the input signal.

6. The apparatus according to claim 1, wherein the phoneme sound detection module includes at least one phoneme sound attribute detection module to detect the presence of a predetermined phoneme sound attribute of the at least one phoneme in the sound signal.

7. The apparatus according to claim 6, wherein the at least one phoneme sound attribute includes a frequency signature corresponding to the at least one phoneme.

8. The apparatus according to claim 7, wherein the frequency signature includes an impulse frequency phoneme sound attribute.

9. The apparatus according to claim 7, wherein the frequency signature includes a wideband frequency phoneme sound attribute.

10. The apparatus according to claim 7, wherein the frequency signature includes a narrowband frequency phoneme sound attribute.

11. The apparatus according to claim 1, wherein the phoneme sound detection module is a composite phoneme sound detection module comprising at least two phoneme sound detection modules.

12. The apparatus according to claim 1, wherein the phoneme sound detection module is a monolithic phoneme sound detection module.

13. The apparatus according to claim 6, wherein the at least one phoneme sound attribute includes at least one sound amplitude corresponding to the at least one phoneme.

14. The apparatus according to claim 6, wherein the at least one phoneme sound attribute includes at least one sound phase corresponding to the at least one phoneme.

15. The apparatus according to claim 1, wherein the sound input includes at least one sound file.

16. The apparatus according to claim 1, wherein the sound input includes at least one microphone.

17. The apparatus according to claim 6, further comprising at least one calibration profile including at least one phoneme attribute threshold value relative to which the at least one phoneme sound attribute detection module detects the presence of the predetermined phoneme sound attribute of the at least one phoneme in the sound signal.

18. The apparatus according to claim 17, wherein the at least one phoneme sound attribute detection module determines that the predetermined phoneme sound attribute is greater than the at least one phoneme attribute threshold value.

19. The apparatus according to claim 17, wherein the at least one phoneme sound attribute detection module determines that the predetermined phoneme sound attribute is less than the at least one phoneme attribute threshold value.

20. The apparatus according to claim 17, wherein the at least one phoneme sound attribute detection module determines that the predetermined phoneme sound attribute is within a predetermined range relative to the at least one phoneme attribute threshold value.

21. The apparatus according to claim 1, wherein the at least one phoneme includes a consonant sound phoneme.

22. The apparatus according to claim 1, wherein the at least one phoneme includes a vowel sound phoneme.

23. The apparatus according to claim 1, wherein the at least one phoneme includes a consonant digraph sound phoneme.

24. The apparatus according to claim 1, wherein the at least one phoneme includes a short vowel sound phoneme.

25. The apparatus according to claim 1, wherein the at least one phoneme includes a long vowel sound phoneme.

26. The apparatus according to claim 1, wherein the at least one phoneme includes an other vowel sound phoneme.

27. The apparatus according to claim 1, wherein the at least one phoneme includes a dipthong vowel sound phoneme.

28. The apparatus according to claim 1, wherein the at least one phoneme includes a vowel sound influenced by r phoneme.

29. The apparatus according to claim 1, wherein the dictionary includes at least one word selected from the following group of words: fast, slow, start or stop.

30. The apparatus according to claim 29, wherein the at least one phoneme includes the /s/ phoneme.

31. The apparatus according to claim 29, wherein the at least one control action includes an action to affect the speed of a metronome.

32. The apparatus according to claim 3, wherein the speech recognition engine uses an ASR (Automatic Speech Recognition) system that uses ML (machine learning) to improve its accuracy, by adapting the ASR by including means for: (1) providing a welcome message to the user, to explain that their recordings will be used to improve the ASR's acoustic model; (2) providing a confirmation button or check box or the like to enable the user to give their consent; (3) looking up the next speech occurrence that has not been captured yet and presenting it to the user; (4) recording as the occurrence is being spoken by the user; (5) automatically sending the audio data to a predetermined directory; (6) enabling a person to review the audio data manually before including it in the ASR's ML mechanism; and (7) marking the recording for this occurrence for this user as processed.

33. A phoneme sound based controller method, the method comprising the steps of:
(a) providing a sound input for receiving a sound signal;
(b) providing a phoneme sound detection module connected to the sound input to determine if at least one phoneme is detected in the sound signal;
(c) providing a dictionary containing at least one word, the word comprising at least one syllable, the syllable comprising the at least one phoneme;
(d) providing a grammar containing at least one rule, the at least one rule containing the at least one word, the at least one rule further containing at least one control action;
wherein the at least one control action is taken if the at least one phoneme is detected in the sound input signal by the phoneme sound detection module.
